(19) United States
(12) Patent Application Publication
(10) Pub. No.: US 2018/0217390 A1
(43) Pub. Date: Aug. 2, 2018

(54) NAKED-EYE STEREOSCOPIC DISPLAY DEVICE

(71) Applicant: Wuhan China Star Optoelectronics Technology Co., Ltd., Wuhan, Hubei (CN)

(72) Inventor: Guowei ZHA, Shenzhen, Guangdong (CN)

(73) Assignee: Wuhan China Star Optoelectronics Technology Co., Ltd., Wuhan, Hubei (CN)

(21) Appl. No.: 15/124,332

(22) PCT Filed: Jul. 20, 2016
(86) PCT No.: PCT/CN2016/090602

§ 371 Date: Sep. 7, 2016

(30) Foreign Application Priority Data
Jun. 7, 2016 (CN) 201610399223.9

(51) Int. Cl. G02B 27/22; F21V 8/00

(52) U.S. Cl. CPC G02B 27/2214; G02F 1/133528; G02B 6/0048

(57) ABSTRACT

The invention provides a naked-eye stereoscopic display device. The naked-eye stereoscopic display device includes a backlight module, a liquid crystal panel and a lens component successively stacked in that order. The lens component includes several lens elements arranged in a predetermined manner, and in an arrangement direction of the lens elements, a full width at half maximum of a curve of light intensity changing with angle for output light of the backlight module is less than or equal to 10°. The invention can eliminate secondary viewpoints, and therefore can effectively increase brightness of main viewpoints during 3D display, reduce image crosstalk between adjacent pixels and further significantly reduce the overall thickness of the display device.

### TECHNICAL FIELD

The invention relates to the field of display technology, and more particularly to a naked-eye stereoscopic display device.

### DESCRIPTION OF RELATED ART

The 3D display technology has become an inevitable development trend of the future display technology because it can reproduce the human familiar cognitive style in the nature, and a naked-eye 3D technology is very popular due to it has gotten rid of complicated auxiliary equipments.

There are a variety of ways to achieve naked-eye 3D display, such as a grating technology, a lens technology and the like. Because the grating technology can effectively block the image crosstalk between different viewpoints, it has a better stereoscopic display effect, but meanwhile it also faces a regret of brightness lossing. In the current environment that the 3D display technology has not completely replaced the 2D display technology, the naked-eye 3D solution based on lens has become the present optimum technical solution due to it can reduce the impact on the 2D image brightness to the minimal degree.

FIG. 1 is a conventional structural schematic view of a lens-based naked-eye stereoscopic display device, and the lens-based naked-eye stereoscopic display device includes a LED 101, a light guide plate 102, a diffusion sheet 103, a lower polarizer 12, a liquid crystal display panel 13, an upper polarizer 14, a lens layer 3D module 15. Sub-pixels corresponding to the liquid crystal display panel 13 are generally placed on the position of focal plane of the lens layer 3D module 15, because of a focal length of the lens layer 3D module 15 is generally in a range of about 600-1000 μm, which objectively increases the thickness of the 3D display device. In addition, in order to ensure uniform distribution of a light field of the liquid crystal display panel, a structure being the diffusion sheet 103 is generally used to uniformize the light filed. FIG. 2 is a curve diagram of light intensity changing with angle of the display device in FIG. 1, it obviously still has a significant light field distribution when at oblique viewing, which is advantageous in improving the viewing angle of the display device. However light rays will go through adjacent lens structures and thereby form secondary viewpoints 17 as shown in FIG. 3 when in 3D display resulting from the presence of oblique light rays, and therefore it objectively reduces the brightness of main viewpoints 16. FIG. 3 is a principle diagram of the display device in FIG. 1.

### SUMMARY

An objective of the invention is to provide a naked-eye stereoscopic display device, which can solve the problems of the prior art that the thickness of the display device is too large and the presence of the secondary viewpoints leads to the reduction of brightness of the main viewpoints.

In order to achieve the above objective, a technical solution provided by the invention to provide a naked-eye stereoscopic display device. The naked-eye stereoscopic display device includes a backlight module, a liquid crystal panel and a lens component successively stacked in that order. The lens component includes several (i.e., more than one) lens elements arranged in a predetermined manner, and in the arrangement direction of the lens elements, a full width at half maximum of a curve of light intensity changing with angle for an output light of the backlight module is less than or equal to 5° (i.e., 5 degrees). The lens elements are lenticular lenses sequentially arranged along a predetermined direction. The backlight module includes a light source and a light guide plate. The light guide plate includes a light output surface, a bottom surface opposite to the light output surface and a plurality of side surfaces connecting the light output surface with the bottom surface. A thickness of the light guide plate is changed in a stepwise manner, and the light source is disposed at a side with relatively smaller thickness of the light guide plate.

In an embodiment, the bottom surface includes multiple (i.e., more than one) horizontal portions which are parallel to light output surface and spacedly disposed from one another and light extraction portions each of which is connected between adjacent two of the horizontal portions. Distances between the horizontal portions and the light output surface are gradually increased in a direction facing away from the light source.

In an embodiment, when being observed in a direction perpendicular to the light output surface, the light extraction portions each are disposed with a circular arc shape, and an arc center of the light extraction portion and the light source are located at opposite sides of the light extraction portion.

In an embodiment, focal lengths of arc surfaces of the light extraction portions are gradually decreased in the direction facing away from the light source.

In order to achieve the above objective, another technical solution provided by the invention is to provide a naked-eye stereoscopic display device. The naked-eye stereoscopic display device includes a backlight module, a liquid crystal panel and a lens component successively stacked. The lens component includes several lens elements arranged in a predetermined manner, and in the arrangement direction of the lens elements, a full width at half maximum of a curve of light intensity changing with angle for an output light of the backlight module is less than or equal to 10°.

In an embodiment, the full width at half maximum of the curve of light intensity changing with angle is less than or equal to 5°.

In an embodiment, the lens elements are lenticular lenses sequentially arranged along a predetermined direction.

In an embodiment, the backlight module includes a light source and a light guide plate, the light guide plate includes a light output surface, a bottom surface opposite to the light output surface and a plurality of side surfaces connecting the light output surface and the bottom surface. A thickness of the light guide plate is changed in a stepwise manner, and the light source is disposed at a side with relatively smaller of the light guide plate.

In an embodiment, the bottom surface includes multiple horizontal portions which are parallel to the light output surface and spacedly disposed from each other and light extraction portions which are connected between every adjacent two of the horizontal portions. Distances between the horizontal portions and the light output surface gradually are increased in a direction facing away from the light source.

In an embodiment, when being observed in a direction perpendicular to the light output surface, the light extraction portions each are disposed with a circular arc shape, and an arc center of the light extraction portion and the light source are located at opposite sides of the light extraction portion.

In an embodiment, focal lengths of arc surfaces of the light extraction portions are gradually decreased along the direction facing away from the light source.

In an embodiment, the focal length of the arc surface of each light extraction portion satisfies the following equation:

f=W+L,

where f is the focal length of the arc surface of the light extraction portion, W is a distance between a side of the light guide plate where the light source is located and another side far away from and opposite to the light source, L is a distance between an arc peak of the light extraction portion and the another side of the light guide plate far away from and opposite to the light source.

In an embodiment, the arrangement direction of the light extraction portions is perpendicular to the arrangement direction of the lens elements.

In an embodiment, the light source is a point light source.

In an embodiment, a lower polarizer is disposed above the backlight module, the liquid crystal panel is disposed above the lower polarizer, an upper polarizer is disposed above the liquid crystal panel, and the lens component is disposed above the upper polarizer.

In an embodiment, the full width at half maximum of the curve of light intensity changing with angle is 4° or 3°.

Beneficial effects can be achieved by the invention are that: different from the prior art, the invention uses a directional backlight to control the output angular distribution of light, the full width at half maximum of a curve of light intensity of an output light changing with angle is less than or equal to 10°, a parallel light is outputted in the plane perpendicular to the arrangement direction of the lens component and then can obtain a naked-eye display effect after passing through the lens component. Because the output light is the parallel light, the problem that the oblique light passes through adjacent lens elements does not occur any more, so that it can eliminate the secondary viewpoints, effectively increase the brightness of main viewpoints during 3D display, and reduce the image crosstalk between adjacent pixels. In the lens-based naked-eye stereoscopic display device, the sub-pixels corresponding to the liquid crystal panel do not need to be disposed in the focal plane position of the lens component, and therefore it can significantly reduce the overall thickness of the display device.

### BRIEF DESCRIPTION OF THE DRAWINGS

FIG. 1 is a structural schematic view of a conventional lens-based naked-eye stereoscopic display device.

FIG. 2 is a curve diagram of light intensity changing with angle of the display device in FIG. 1.

FIG. 3 is a principle diagram of the display device in FIG. 1.

FIG. 4 is a structural schematic view of an embodiment of a naked-eye stereoscopic display device of the invention.

FIG. 5 is a top view of FIG. 4.

FIG. 6 is a curve diagram of light intensity changing with angle of the display device in FIG. 4.

FIG. 7 is a principle diagram of the naked-eye stereoscopic display device of the invention.

FIG. 8 is a side view of an embodiment of a light guide plate of the naked-eye stereoscopic display device of the invention.

FIG. 9 is a top view of an embodiment of the light guide plate of the naked-eye stereoscopic display device of the invention.

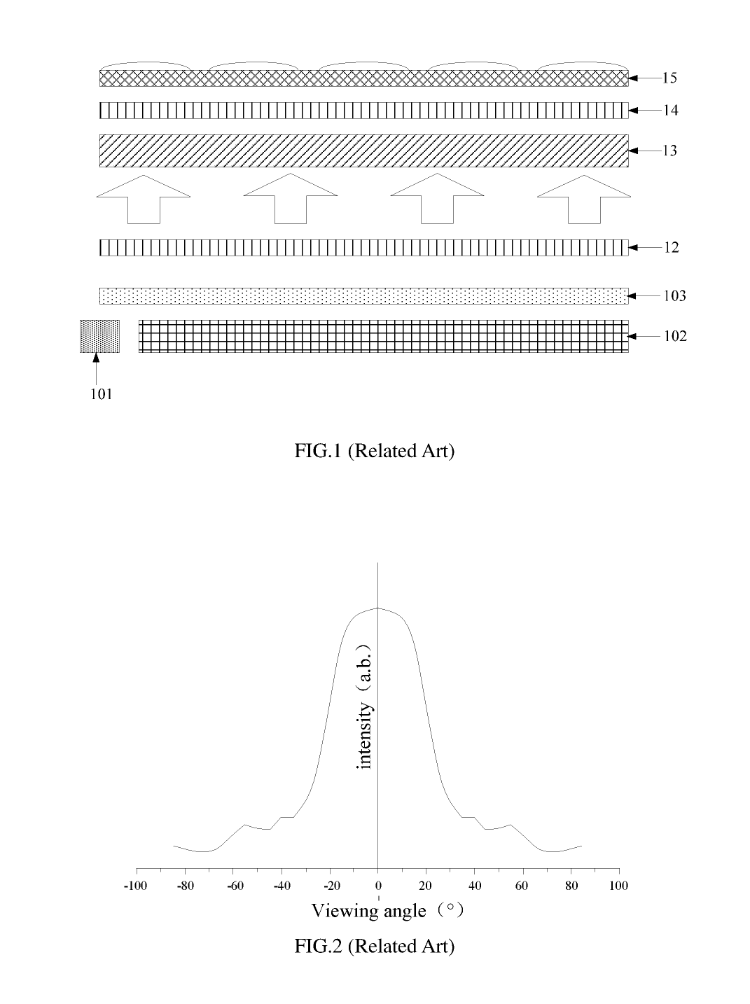

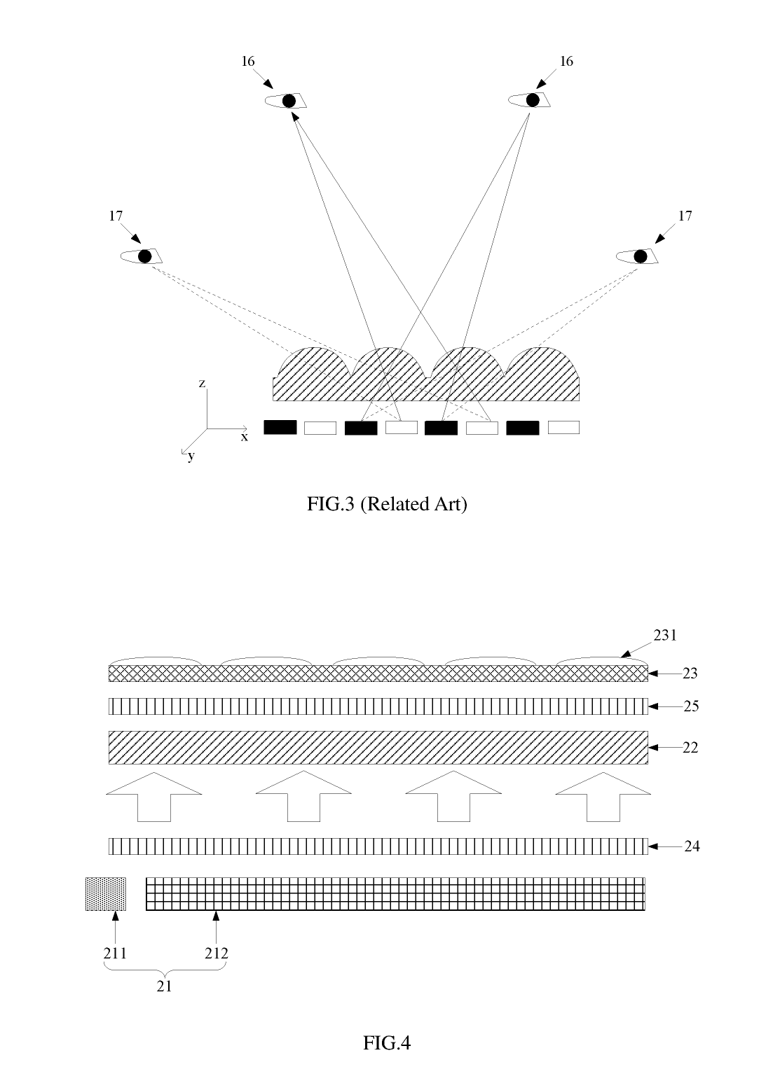

### DETAILED DESCRIPTION OF EMBODIMENTS

In order to make the skilled person in the art better understand the technical solutions of the invention, a naked-eye stereoscopic display device provided by the invention will be described in detail below by specific embodiments in conjunction with accompanying drawings.

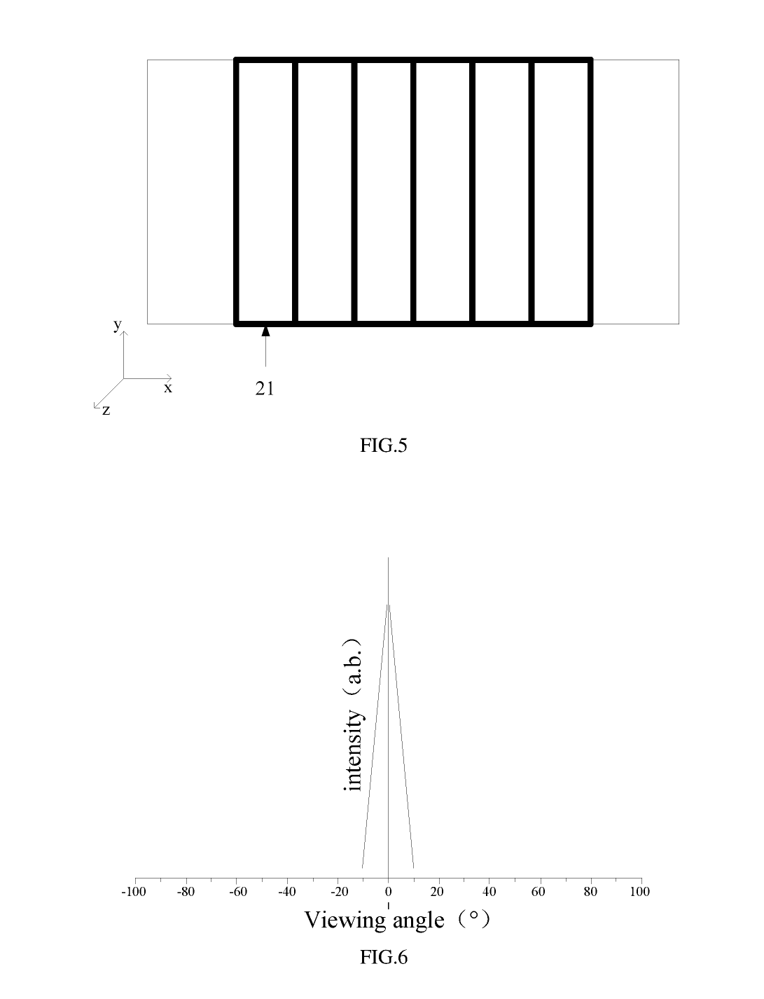

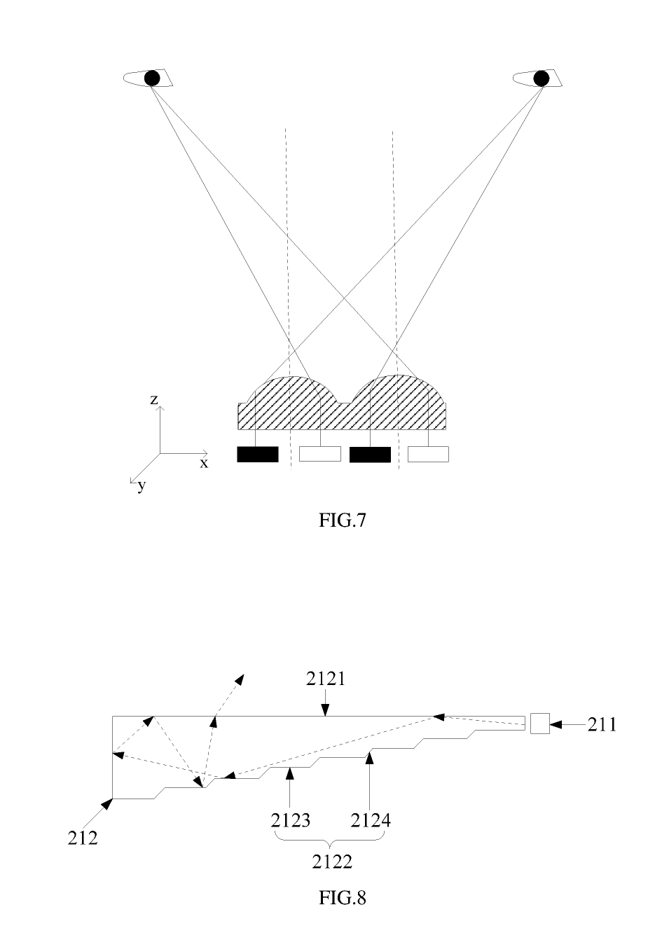

Referring to FIG. 4, FIG. 5, FIG. 6 and FIG. 7, FIG. 4 is a structural schematic view of an embodiment of a naked-eye stereoscopic display device of the invention, FIG. 5 is a to view of FIG. 4, FIG. 6 is a curve diagram of light intensity changing with angle of the display device in FIG. 4, and FIG. 7 is a principle diagram of a naked-eye stereoscopic display device of the invention.

The invention provides a naked-eye stereoscopic display device, and the naked-eye stereoscopic display device includes a backlight module 21, a liquid crystal panel 22 and a lens component 23 successively stacked in that order. The lens component 23 includes several lens elements 231 arranged in a predetermined manner. In an arrangement direction of the lens elements 231, a full width at half maximum (FWHM) of the curve of light intensity of output light of the backlight module 21 changing with angle is less than or equal to 10°.

More specifically, a lower polarizer 24 is disposed above the backlight module 21, the liquid crystal panel 22 is disposed above the lower polarizer 24, an upper polarizer 25 is disposed above the liquid crystal panel 22, and the lens component 23 is disposed above the upper polarizer 25.

Referring to FIG. 5, y direction is defined as a direction parallel to the lens elements 231, x direction is defined as a direction perpendicular to the lens elements, and z direction is defined as a direction perpendicular to the plane of FIG. 5. The backlight module 21 is a directional backlight module, and the emitted light of the backlight module 21 is distributed along a plane perpendicular to the x direction. A curve of light intensity changing with angle is shown in FIG. 6, and it can be seen from FIG. 6 that the light intensity has a minimal angular distribution, and therefore the emitted light after passing through the lens component 23 will be converged onto focal points, as shown in FIG. 7. The sub-pixels for a same viewpoint would be converged onto main viewpoints after passing through respective different focal points and, thereby achieve a naked-eye stereoscopic display effect.

In addition, the sub-pixels are not limited to be placed in the position of the focal plane of the lens component 23, as far as reducing the thickness of the module is considered, a spacing/gap between the sub-pixels and the lens component 23 is generally made to be less than the magnitude of the focal length of the lens component 23.

Because that the directional backlight has only a paraxial (also generally referred to as near-axis) parallel light distribution in the x direction, and therefore the problem that an oblique light passes through the adjacent lens elements 231 does not exist any more, it objectively increases the brightness of the 3D main viewpoints, and therefore it is beneficial to improve the 3D display effect and reduce the image crosstalk between adjacent pixels.

Different from the prior art, the invention uses the directional backlight to control the output angular distribution of the light, which makes a full width at half maximum of a curve of light intensity of the output light changing with angle be less than or equal to 10°, so that a parallel light would be outputted in the plane perpendicular to the arrangement direction of the lens component 23 and then achieves a naked-eye 3D display effect after passing through the lens component 23. Because the output light is the parallel light, the problem that the oblique light passes through the adjacent lens elements 231 does not occur any more, the secondary viewpoints in the prior art are eliminated, the brightness of main viewpoints during 3D display is effectively increased and the image crosstalk between adjacent pixels is reduced. Moreover, in the lens-based naked-eye stereoscopic display device, the sub-pixels corresponding to the liquid crystal panel 22 do not need to be disposed in the focal plane position of the lens component 23, and therefore it can significantly reduce the overall thickness of the display device.

In an embodiment, a full width at half maximum of a curve of light intensity changing with angle is less than or equal to 5°, for example 4° or 3°, and so on.

The lens elements 231 of the embodiment are lenticular lenses sequentially arranged along a predetermined direction.

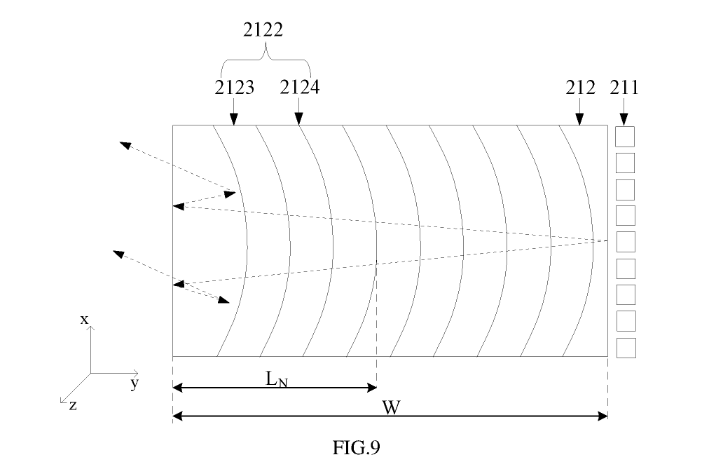

The directional backlight structure has a variety of implementations, as shown in FIG. 8 and FIG. 9. FIG. 8 is a side view of an embodiment of a light guide plate of a naked-eye stereoscopic display device of the invention. FIG. 9 is a top view of an embodiment of a light guide plate of a naked-eye stereoscopic display device of the invention.

More specifically, the backlight module 21 of the illustrated embodiment includes a light source 211 and a light guide plate 212. The light guide plate 212 includes a light output surface 2121, a bottom surface 2122 opposite to the light output surface 2121, and multiple (i.e., more than one) side surfaces connecting with the light output surface 2121 and the bottom surface 2122. The light guide plate 212 as a whole is shown as a wedge-shaped structure, i.e., thicknesses of two ends of the light guide plate 212 are different. For example, in the illustrated embodiment, the thickness of the light guide plate 212 is changed in a stepwise manner and the light source 211 is disposed at a side of the light guide plate 212 with relatively smaller thickness. The light source 211 is a point light source, such as a LED light source as illustrated in the embodiment.

The bottom surface 2122 includes a plurality of horizontal portions 2123 spaced from one another and parallel to the light output surface 2121, and light extraction portions 2124 connected among the horizontal portions 2123. Distances between the horizontal portions 2123 and light output surface 2121 are gradually increased along a direction far away from the light source 211. As shown in FIG. 9, when observing in the direction perpendicular to the light output surface, the light extraction portions 2124 each are circular arc-shaped, which can guide the emitted light rays from the light source 211 to redistribute along the x direction. An arc center of each the light extraction portion 2124 and the light source are located on opposite sides of the light extraction portion 2124. An arrangement direction of the light extraction portions 2124 in the illustrated embodiment is perpendicular to the arrangement direction of the lens elements 231.

As shown in FIG. 8, when observing from a side, the light extraction portions 2124 each have a ramp feature or other curve feature in the x-z plane, and the purpose is to compress/reduce light incident angles of light rays relative to the light output surface 2121 at the top of the light guide plate 212, and thereby destroy the total reflection characteristics so that the light can escape from the light output surface 2121 and then illuminate the liquid crystal panel 22.

More specifically, a focal length of the arc surface of each light extraction portion 2124 satisfies the following equation:

f=W+L,

where f is the focal length of the arc surface of the light extraction portion 2124, W is a distance between a side of the light guide plate 212 where the light source 211 locates (i.e., generally the side near the light source 211) and another side opposite to the light source 211 (i.e., generally the side far away from the light source 211), and L is a distance between an arc peak of the light extraction portion 2124 and the side of the light guide plate 212 far away from and opposite to the light source 211.

The focal lengths of the arc surfaces of the light extraction portions 2124 are gradually decreased along a direction far away from the light source 211. Please continue to refer to FIG. 9, the arc surfaces 1, 2, . . . , N, . . . , have corresponding curvatures and corresponding focal lengths f₁<f₂< . . . <f_{N} . . . , i.e., the focal lengths of the arc surfaces have different magnitudes/sizes in a distribution along the y direction, so that the light source 211 is located near the focal point positions of the arc surfaces, i.e., f_{N}=W+L_{N}. Based on the basic principle that light rays near a focal point would emit as parallel light rays, the output light would have a minimal angular distribution along the x direction after passing through the light extraction portion 2124 and approximately be a parallel light.

In summary, the invention can eliminate the secondary viewpoints in the prior art and therefore can effectively increase the brightness of the main viewpoints during 3D display, reduce the image crosstalk between adjacent pixels and further significantly reduce the thickness of the display device.

It should be understood that the foregoing discussion only is some embodiments of the invention, and therefore it is not limited to the protection scope of the invention, any equivalent structures or equivalent transformation of processes made based on the specification and the accompanying drawings of the invention, such as the mutual combination of technical features of various embodiments, or directly or indirectly used in other related technical field, are similarly included within the protection scope of the invention.

What is claimed is:

1. A naked-eye stereoscopic display device, wherein the naked-eye stereoscopic display device comprises a backlight module, a liquid crystal panel and a lens component successively stacked;
the lens component comprising a plurality of lens elements arranged in a predetermined manner, and in an arrangement direction of the plurality of lens elements, a full width at half maximum of a curve of light intensity changing with angle for an output light of the backlight module is less than or equal to 5°, the plurality of lens elements are lenticular lenses sequentially arranged along a predetermined direction;
the backlight module comprising a light source and a light guide plate, the light guide plate comprising an light output surface, a bottom surface opposite to the light output surface and a plurality of side surfaces connecting the light output surface and the bottom surface, a thickness of the light guide plate changing in a stepwise manner, and the light source being disposed at a side with relatively smaller thickness of the light guide plate.

2. The naked-eye stereoscopic display device according to claim 1, wherein the bottom surface comprises a plurality of horizontal portions spaced from each other and parallel to the light output surface and light extraction portions connected among the horizontal portions, distances between the horizontal portions and the light output surface are gradually increased in a direction facing away from the light source.

3. The naked-eye stereoscopic display device according to claim 2, wherein when observing in the direction perpendicular to the light output surface, the light extraction portions each are circular arc-shaped, and an arc center of the light extraction portion and the light source are located at opposite sides of the light extraction portion.

4. The naked-eye stereoscopic display device according to claim 3, wherein focal lengths of arc surfaces of the light extraction portions are gradually decreased in the direction far away from the light source.

5. A naked-eye stereoscopic display device, wherein the naked-eye stereoscopic display device comprises a backlight module, a liquid crystal panel and a lens component successively stacked, the lens component comprises a plurality of lens elements arranged in a predetermined manner, and in an arrangement direction of the plurality of lens elements, a full width at half maximum of a curve of light intensity changing with angle for an output light of the backlight module is less than or equal to 10°;

6. The naked-eye stereoscopic display device according to claim 5, wherein the full width at half maximum of the curve of light intensity changing with angle is less than or equal to 5°.

7. The naked-eye stereoscopic display device according to claim 5, wherein the plurality of lens elements are lenticular lenses sequentially arranged along a predetermined direction.

8. The naked-eye stereoscopic display device according to claim 5, wherein the backlight module comprises a light source and a light guide plate;
the light guide plate comprises a light output surface, a bottom surface opposite to the light output surface and a plurality of side surfaces connecting the light output surface and the bottom surface, a thickness of the light guide plate is changed in a stepwise manner, and the light source is disposed at a side with relatively smaller thickness of the light guide plate.

9. The naked-eye stereoscopic display device according to claim 8, wherein the bottom surface comprises a plurality of horizontal portions spaced from one another and parallel to the light output surface and a light extraction portion connecting between each adjacent two of the horizontal portions, distances between the horizontal portions and the light output surface are gradually increased in a direction facing away from the light source.

10. The naked-eye stereoscopic display device according to claim 9, wherein when being observed in a direction perpendicular to the light output surface, the light extraction portion is circular arc-shaped, and an arc center of the light extraction portion and the light source are located at opposite sides of the light extraction portion.

11. The naked-eye stereoscopic display device according to claim 10, wherein focal lengths of arc surfaces of a plurality of the light extraction portions are gradually decreased in the direction facing away from the light source.

12. The naked-eye stereoscopic display device according to claim 11, wherein the focal length of the arc surface of each light extraction portion satisfies a following equation:
f=W+L,
where f is the focal length of the arc surface of the light extraction portion, W is a distance between a side of the light guide plate where the light source is located and another side far away from and opposite to the light source, and L is a distance between an arc peak of the light extraction portion and the another side of the light guide plate far away from and opposite to the light source.

13. The naked-eye stereoscopic display device according to claim 10, wherein an arrangement direction of a plurality of the light extraction portions is perpendicular to the arrangement direction of the plurality of lens elements.

14. The naked-eye stereoscopic display device according to claim 8, wherein the light source is a point light source.

15. The naked-eye stereoscopic display device according to claim 5, wherein a lower polarizer is disposed above the backlight module, the liquid crystal panel is disposed above the lower polarizer, an upper polarizer is disposed above the liquid crystal panel, and the lens component is disposed above the upper polarizer.

16. The naked-eye stereoscopic display device according to claim 5, wherein the full width at half maximum of the curve of light intensity changing with angle is 4° or 3°.
